(19) United States
(12) Patent Application Publication
(10) Pub. No.: US 2014/0043931 A1
(43) Pub. Date: Feb. 13, 2014

(54) Container with Internal Structure for Mixing

(71) Applicant: Edwin Figueroa, Carol Stream, IL (US)

(72) Inventor: Edwin Figueroa, Carol Stream, IL (US)

(21) Appl. No.: 13/569,963

(22) Filed: Aug. 8, 2012

(51) Int. Cl. B01F 13/00

(52) U.S. Cl. CPC B01F 13/0011
USPC 366/130

(57) ABSTRACT

A container for mixing fluids disposed within. The container has a top surface for receiving a lid and a side wall extending from a base or bottom surface. The container has an inner surface from which a plurality of baffles extend toward the center of the container. The container includes a handle connected to the container on opposing sides of the container. The user grips the handle and utilizes the user's natural inclination to rotate the wrist, and accordingly the container, to agitate the contents within. The contents are agitated by movement and contact with the baffles within the container. The baffles can be any shape, size, or orientation.

### FIELD OF THE INVENTION

This invention relates in general to containers, in particular containers with internal structures to assist in mixing fluids therein.

### BACKGROUND OF THE INVENTION

Containers are commonly used to hold a supply of fluid. Certain types of fluid may require agitation to maintain uniform consistency of the fluid. Paint, for example, typically requires some agitation or mixing before using.

Prior art discloses the use of dashers to agitate the contents within a container. U.S. Pat. Nos. 718,319, 970,823, and 975,380 describe butter churns requiring external actuation of a dasher to impart movement to the contents in the churn. Such prior art also utilize, in conjunction with a dasher, vertical members disposed on the interior of the container to deflect, or interrupt the flow of current within the container. U.S. Pat. No. 531,718 discloses an apparatus for aging liquors utilizing rotating blades and internal radial ribs for agitation of the liquor. U.S. Pat. No. 789,599 discloses a paint mill utilizing a wheel for impelling or striking the tank contents by centrifugal action so as to deliver the tank-contents upon vertically disposed offsets or baffle-plates arranged on the inner lateral surface of the tank.

U.S. Pat. No. 4,875,781 discloses a paint container wherein internal mixing of the paint is effected by oscillation of the paint can by the associated handle, and a plurality of diametrically opposed arcuate vanes secured to the interior surface wall of the paint container.

U.S. Patent Application Publication 2006/0187746 discloses a container for mixing paint with at least one protrusion extending upward from the base to promote movement of the fluid when the container is shaken.

Various disadvantages within the prior art are overcome by the present invention.

The present inventor has recognized the need for a container which allows for easier mixing of fluids.

The present inventor has recognized the need for a container which can be efficiently manufactured. The present inventor has recognized the need for a container that is capable allowing a user easily mix the liquid contents of the container without first removing the lid of the container.

### SUMMARY OF THE INVENTION

In one embodiment, the container is a cylindrical shaped container, such as a paint can, with a bottom surface and a top surface suitable for receiving a lid. The top surface can comprise a rim. The container has an inner surface from which a plurality of baffles protrude and extend toward the center of the container. The container has a handle with ends connected to the container via handle attachments. Ends of the handle are disposed within the handle attachment and allows the handle to swing about the handle attachment. In use, the user grips the handle and allows for the user's natural inclination for rotating their wrist to impart rotational movement to the container. Rotational movement of the container causes agitation of the fluid within the container as the fluids come in contact with the baffles.

The baffles can be any shape, size, or orientation, and extend any distance from the inner surface towards the center of the container. The baffle can extend from the base of the container to a distance below the height of the container. Any number of baffles can be used. In one embodiment the baffles extend from the inner surface of the container at an angle with respect to the center of the container.

The shape, size, orientation, and number of baffles can depend on the type of fluid within the container, the size and shape of the container, and the desired fluid dynamics.

In one embodiment, the paint container comprises molded plastic wherein each inward extension of the baffle towards the center of the paint container corresponds to an exterior indentation which enhances the grip on the container.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a perspective view of one exemplary embodiment of the container.

FIG. 2 is a top view of the container in FIG. 1.

FIG. 3 is a cross-sectional view of an alternate embodiment of the container.

FIG. 4 is a perspective view of yet another embodiment of the container.

FIG. 5 is a cross sectional view of an alternate embodiment of the container.

FIG. 6 is a cross sectional view of an alternate embodiment of the container.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

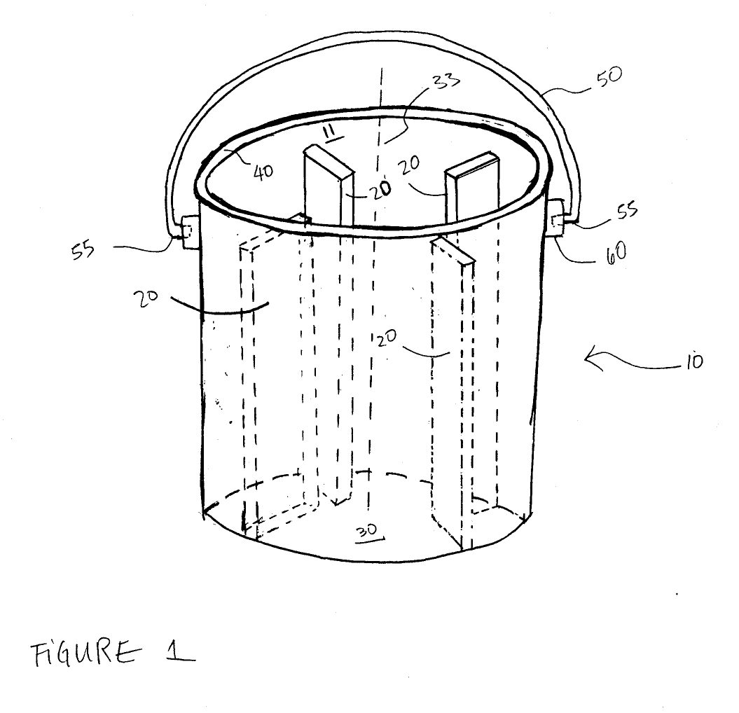

FIG. 1 illustrates one embodiment of a container 10 which is a cylindrical shaped container such as a paint can, comprising a bottom surface 30 and a top surface with a rim 40 suitable for receiving a lid (not shown). The container 10 has an inner surface 11 from which a plurality of baffles 20 extend toward the center of the container. The container has a handle 50 connected to the container 10 via a handle attachment 60. Ends 55 of the handle are disposed within the handle attachment 60 and allows the handle to swing about the handle attachment 60.

Baffles can be any shape, size or orientation. The baffle can extend from the base 30 of the container and rise to a height below the rim 40. The number of baffles can vary according to the desired type of fluid dynamic for the particular fluid. For example, various embodiments of the invention may include any of 1, 2, 3, 4 or more baffles. The shape, size, and orientation of the baffles can also depend on the type of fluid within the container, the size and shape of the container, and the desired fluid dynamics for the particular fluid.

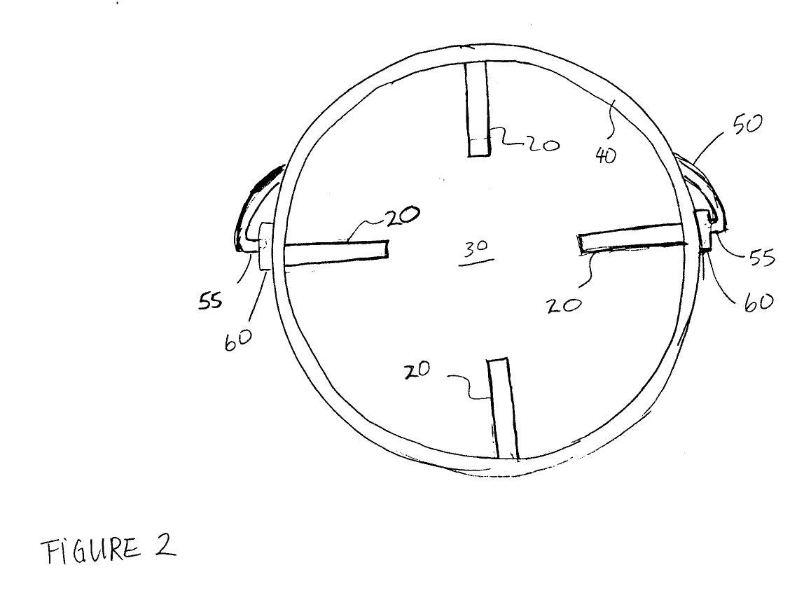

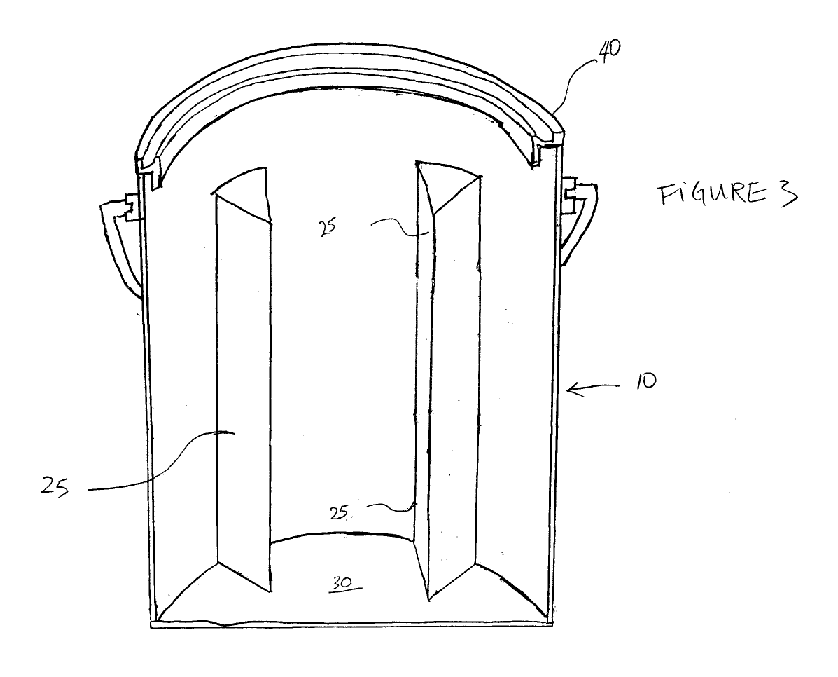

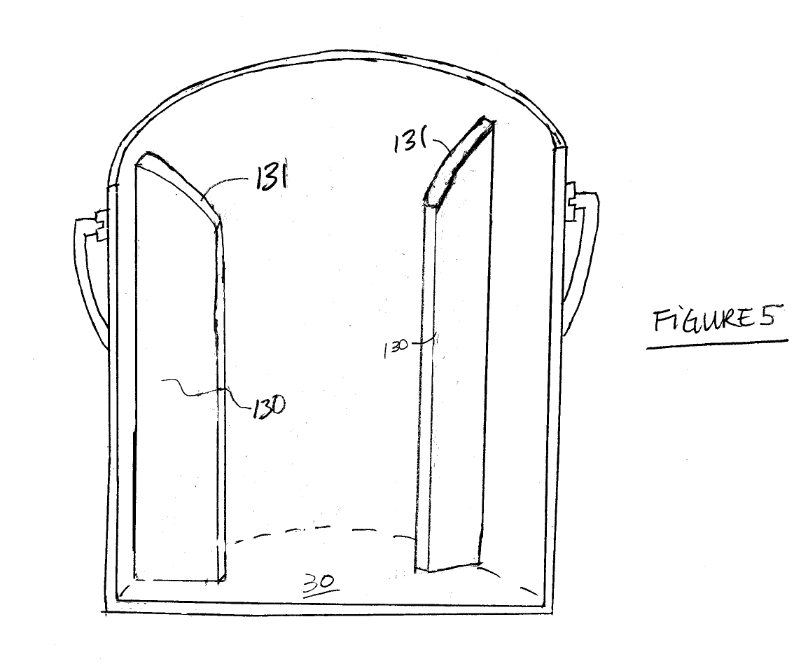

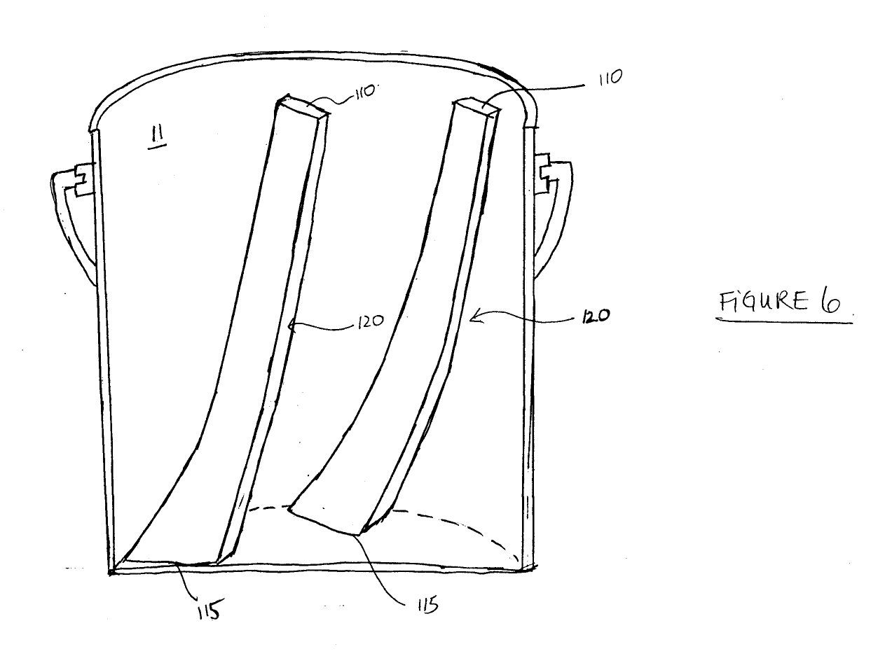

FIGS. 1 and 2 illustrate four rectangular shaped baffles disposed evenly apart from one another along the circumference of the container. Each baffle extends perpendicularly from the inner surface 11 towards the central axis 33 of the cylindrical container 10. Baffles can be spaced apart at intervals other than ninety degrees apart, and can extend from the inner surface 11 in a non-perpendicular, or angled orientation. FIG. 3 illustrates a cross sectional view of an alternate embodiment of the container 10. Like numbers denote the same components. The baffles 25 in FIG. 3 are triangular in shape. Any other shaped baffle can be used, for example, such as a rounded baffle or protrusion, a continuous corrugated inner surface, a helical baffle (FIG. 6). In one embodiment, as illustrated in FIG. 5, the baffles 22 can be oriented at an acute angle with respect to the interior surface of the container. In another embodiment, as illustrated in FIG. 6, the baffles 120 may be helical. The baffles may have a smaller width at the top 110 of the baffle than at the bottom 115 of the baffle to minimize the turbulence near the top of the container to prevent spillage. In FIG. 5, the baffles 130 extend from the inner surface and and have a curved upper portion 131 that curves inward toward a top of the baffle to join with the inside wall.

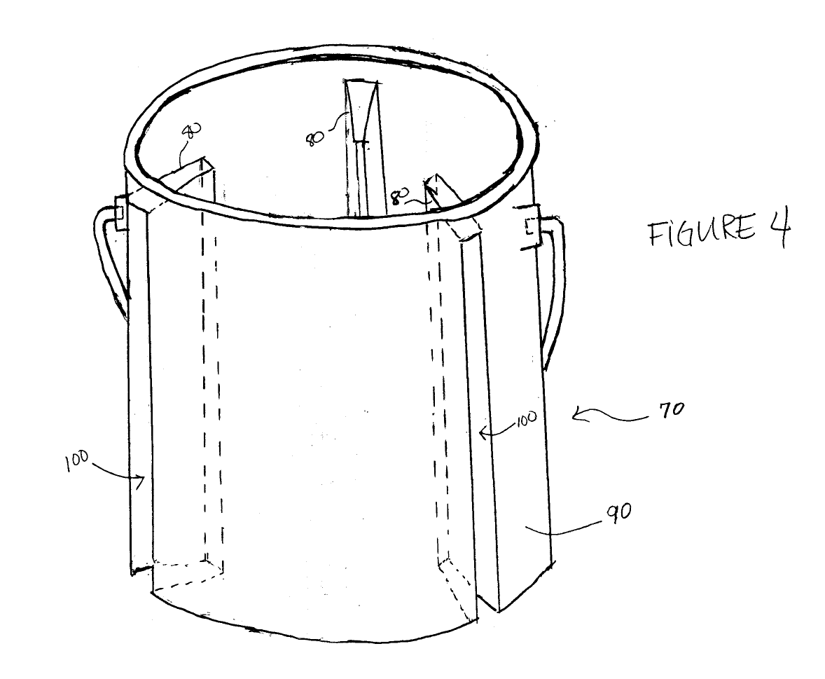

In one embodiment, as illustrated in FIG. 4, the container 70 comprises baffles which protrude inwardly from the exterior surface 90 of the container 70. Each inward extension of the baffle 80 corresponds to an exterior indentation 100 on the exterior surface 90. The exterior indentation 100 provides a ridged or grooved surface which can enhance a user's grip on the side of the container when the container is not held by the handle. The depth of the indentation can vary depending on various considerations such as the size of the container, the weight of the container and its contents, and the shape of the indentation. A deeper indentation provides for more mechanical interlocking between the fingers and the exterior surface of the container for an enhanced grip.

Containers comprising baffles can have larger exterior dimensions than containers without baffles to compensate for the otherwise loss in volume capacity due to the presence of the baffles. Containers comprising baffles can be manufactured to provide a one gallon, five gallon, or any other standard container volume size.

In use, the user grasps the container by its handle. Using a rotational wrist motion, the user rotates the container about a central vertical axis 33. The rotational motion of the container imparts movement to the fluid within the container, causing the contents to swirl within the container. The swirling movement of the fluid causes turbulence in flow of the fluid when the fluid comes into contact with a baffle. The disruption on the swirling motion of the fluid allows the fluid to mix effectively.

The containers can be molded from plastic, including the rim, such that the container is one piece. Alternatively, the side and bottom of the container can be molded from plastic, with the rim 40 being made from a different material such as a metallic material, and then subsequently secured to the top of the container.

The container can be made of plastic, such as acrylonitrie butadiene styrene, polystyrene, polyethylene, polytetrafluorotheylene, polyvinyl chloride, polypropylene, polyethylene terephthalate, any other suitable plastic, or a combination thereof. Other suitable materials can also be used. The container can be manufactured by various types of molding processes known to one skilled in the art, including injection molding, compression molding, or transfer molding. The container may be molded such that components other than the rim are one unitary molded piece, or alternatively, the entire container, including the rim, is molded from one unitary piece.

Containers comprising baffles are not limited to those used for holding paint. In other embodiments, the container may be of a different size, or shape for various uses. In one embodiment, the baffles can be disposed on the inner surface of a container such as a cup or glass for drinking. In an alternate embodiment, the baffles can be disposed on the inner surface of a container such as a jar or pitcher used for mixing beverages. Containers of the present inventions can also be used to mix granules or other small particles.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A handheld container for receiving fluids, comprising:
a base;
a sidewall connected to the base;
the sidewall comprises a plurality of mixing baffles extending from an inside surface of the sidewall toward a central region of the container, each baffle of said plurality of mixing baffles being integrally formed with the inside surface of the sidewall.

2. The container of claim 1, wherein the baffles are in contact with the base.

3. The container of claim 1, wherein the baffles are helical.

4. The container of claim 1, wherein the baffles are evenly spaced apart along an interior surface of the container.

5. The container of claim 1, wherein the baffles are rectangular.

6. The container of claim 1, comprising a rim attached to the sidewall opposite the base, the width of the baffles are greater near the base than near the rim.

7. The container of claim 1, comprising a handle with ends diametrically secured to the sidewall

8. The container of claim 1, wherein the sidewall is a circumferential sidewall, the circumferential side wall together with the base forms an at least semi-enclosed space for receiving fluid, the baffles within the at least semi-enclosed space.

9. The container of claim 1, wherein at least one baffle has a width that is greater at one end of the baffle than at an opposite end of the baffle.

10. A container for receiving fluids, comprising:
a base;
a sidewall connected to the base;
a rim connected to the sidewall configured to receive a lid;
a handle with ends diametrically secured to the sidewall;
a plurality of mixing baffles extending from an interior surface of the sidewall toward a central region of the container, each baffle in contact with the sidewall along at least a portion of a length of the baffle.
the side wall having a plurality of indentations on an exterior surface;

11. The container of claim 10, wherein the sidewall comprises a plurality of indentations on an exterior surface of the side wall; said indentations corresponding to the baffles extending from the inner surface of the side wall towards a central region of the container.

12. The container of claim 10, wherein baffles extend lengthwise along the sidewall for a majority of a length of the sidewall.

13. The container of claim 11, wherein the baffles are evenly spaced along an interior surface of the container.

14. The container of claim 13, wherein the baffles extend for less than half the length of the side wall.

15. The container of claim 11, wherein the depth of the indentations on the exterior surface is sufficient to provide grip on the exterior of the container.

16. A method for mixing fluid within a baffled container having a handle with ends on opposing sides of the container comprising:
grasping the handle of the container;
rotating the container though rotational movement of the wrist;
imparting rotational movement of the wrist to the container;
imparting movement of the container to the contents within;
creating fluid flow against baffles within the container, where the baffles are in contact with a sidewall of the container along at least a portion of a length of the baffle.

17. The method of claim 16, wherein the rotational movement of the wrist further comprises a counterclockwise rotation and a clockwise rotation.

18. The method of claim 16, wherein the step of creating fluid flow is further defined in that the baffles are integrally formed with the inside surface of the sidewall.
